(19) United States
(12) Patent Application Publication
(10) Pub. No.: US 2024/0379288 A1
(43) Pub. Date: Nov. 14, 2024

(54) REACTOR, CONVERTER AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kazuhiro INABA, Mie (JP); Masaya MURASHITA, Mie (JP)

(21) Appl. No.: 18/692,817

(22) PCT Filed: Sep. 20, 2022
(86) PCT No.: PCT/JP2022/035030

§ 371 Date: Mar. 17, 2024

(30) Foreign Application Priority Data
Sep. 29, 2021 (JP) 2021-159001

(51) Int. Cl. H01F 41/061; H01F 27/255; H01F 27/30; H01F 37/00

(52) U.S. Cl. CPC H01F 41/061; H01F 27/255; H01F 27/306; H01F 37/00

(57) ABSTRACT

A reactor comprising a coil that has a wound portion and a magnetic core that has a middle core portion, wherein the wound portion is disposed on the middle core portion, the middle core portion is divided into a first middle core portion and a second middle core portion in a direction along the axis of the wound portion, the relative magnetic permeability of the second middle core portion is larger than the relative magnetic permeability of the first middle core portion, and the central position of the wound portion in a direction along the axis thereof is positioned in a region that is closer to the second middle core portion in comparison to the central position of the middle core portion in a direction along the axis thereof.

### TECHNICAL FIELD

The present disclosure relates to a reactor, a converter and a power conversion device.

This application claims a priority based on Japanese Patent Application No. 2021-159001 filed on Sep. 29, 2021, all the contents of which are hereby incorporated by reference.

### BACKGROUND

Constituent components of a converter to be installed in a vehicle such as a hybrid vehicle include a reactor. Patent Document 1 discloses a reactor provided with a coil and a core formed by combining two core pieces. Each core piece includes a coil arranged portion to be arranged inside the coil and an exposed portion to be arranged outside the coil. The coil arranged portion and the exposed portion are integrally formed. The both core pieces are so combined that end surfaces of the coil arranged portions of the respective core pieces face each other.

### PRIOR ART DOCUMENT

### Patent Document

Patent Document 1: JP 2014-239120 A

### SUMMARY OF THE INVENTION

The present disclosure is directed to a reactor with a coil including a winding portion and a magnetic core including a middle core portion, the winding portion being arranged on the middle core portion, the middle core portion including a first middle core portion and a second middle core portion divided in a direction along an axis of the winding portion, a relative magnetic permeability of the second middle core portion being larger than that of the first middle core portion, and a center position of the winding portion in the direction along the axis being located in a region closer to the second middle core portion than a center position of the middle core portion in the direction along the axis.

### BRIEF DESCRIPTION OF THE DRAWINGS

FIG. 1 is a schematic perspective view showing a reactor according to a first embodiment.

FIG. 2 is a schematic plan view showing the reactor according to the first embodiment.

FIG. 3 is a section along III-III of FIG. 1.

FIG. 4 is a schematic plan view showing a reactor according to a second embodiment.

FIG. 5 is a schematic plan view showing a reactor according to a third embodiment.

FIG. 6 is a configuration diagram schematically showing a power supply system of a hybrid vehicle.

FIG. 7 is a circuit diagram showing an example of a power conversion device provided with a converter.

### DETAILED DESCRIPTION TO EXECUTE THE INVENTION

### Technical Problem

One of performances required for a reactor is a large inductance. As the inductance increases, larger magnetic energy can be stored.

One object of the present disclosure is to provide a reactor having a large inductance. Another object of the present disclosure is to provide a converter provided with the above reactor. Still another object of the present disclosure is to provide a power conversion device provided with the above converter.

### Effect of Present Disclosure

The reactor of the present disclosure can increase an inductance.

### Description of Embodiments of Present Disclosure

First, embodiments of the present disclosure are listed and described.
(1) A reactor according to an embodiment of the present disclosure is provided with a coil including a winding portion and a magnetic core including a middle core portion, the winding portion being arranged on the middle core portion, the middle core portion including a first middle core portion and a second middle core portion divided in a direction along an axis of the winding portion, a relative magnetic permeability of the second middle core portion being larger than that of the first middle core portion, and a center position of the winding portion in the direction along the axis being located in a region closer to the second middle core portion than a center position of the middle core portion in the direction along the axis.

The reactor of the present disclosure can increase an inductance as compared to the case where the center position of the winding portion is the same position as the center position of the middle core portion. The reason for that is that the inductance increases by locating the center position of the winding portion in the region closer to the second middle core portion than the center position of the middle core portion.
(2) In the reactor of (1) described above, a difference between the relative magnetic permeability of the second middle core portion and that of the first middle core portion may be 50 or more.

In the configuration of (2) described above, the inductance is easily increased.
(3) In the reactor of (1) or (2) described above, a distance between the center position of the winding portion and that of the middle core portion may be 1% or more of a length of the winding portion along the axis.

In the configuration of (3) described above, the inductance is easily increased.
(4) In the reactor of (3) described above, the distance may be 1.0 mm or more.

In the configuration of (4) described above, the inductance can be effectively increased.
(5) In the reactor of any one of (1) to (4) described above, the relative magnetic permeability of the first middle core portion may be 5 or more and 50 or less. In the configuration of (5) described above, a predetermined inductance is easily obtained.
(6) In the reactor of any one of (1) to (5) described above, the relative magnetic permeability of the second middle core portion may be 50 or more and 500 or less. In the configuration of (6) described above, a predetermined inductance is easily obtained.
(7) In the reactor of any one of (1) to (6) described above, the first middle core portion may be constituted by a compact of a composite material in which a soft magnetic powder is dispersed in a resin, and the second middle core portion may be constituted by a powder compact of a raw powder containing a soft magnetic powder.

Generally, a relative magnetic permeability of a compact of a composite material is smaller than that of a powder compact. In the configuration of (7) described above, the first middle core portion is constituted by the compact of the composite material and the second middle core portion is constituted by the powder compact. Thus, the relative magnetic permeability of the second middle core portion is larger than that of the first middle core portion.
(8) In the reactor of any one of (1) to (7) described above, the middle core portion may include a gap portion between the first and second middle core portions, and the gap portion may be located inside the winding portion.

In the configuration of (8) described above, a loss due to a leakage magnetic flux from the gap portion can be reduced. The reason for that is that the leakage magnetic flux from the gap portion is reduced by locating the gap portion inside the winding portion as compared to the case where the gap portion is located outside the winding portion.
(9) In the reactor of any one of (1) to (8) described above, the magnetic core may be composed of a first core and a second core, the first core may include the first middle core portion, and the second core may include the second middle core portion.

In the configuration of (9) described above, the assembly workability of the magnetic core is excellent.
(10) A converter according to an embodiment of the present disclosure is provided with the reactor of any one of (1) to (9) described above.

Since the converter of the present disclosure is provided with the reactor of the present disclosure, an inductance of the reactor is large.
(11) A power conversion device according to an embodiment of the present disclosure is provided with the converter of (10) described above.

Since the power conversion device of the present disclosure is provided with the converter of the present disclosure, an inductance of the reactor is large.

### Details of Embodiments of Present Disclosure

Specific embodiments of the present disclosure are described in detail below with reference to the drawings. The same reference signs in figures denote the same components. Note that the present invention is not limited to these illustrations, but is represented by claims and intended to include all changes in the scope of claims and in the meaning and scope of equivalents.

### First Embodiment

### [Reactor]

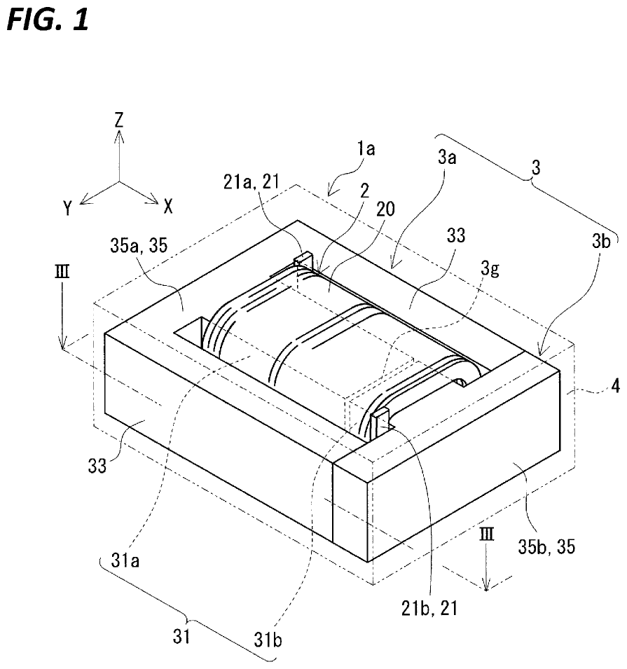

A reactor 1a of a first embodiment is described with reference to FIGS. 1 to 3. The reactor 1a is provided with a coil 2 and a magnetic core 3. The coil 2 includes a winding portion 22. The magnetic core 3 includes a middle core portion 31. The winding portion 20 is arranged on the middle core portion 31. The middle core portion 31 includes a first middle core portion 31a and a second middle core portion 31b.

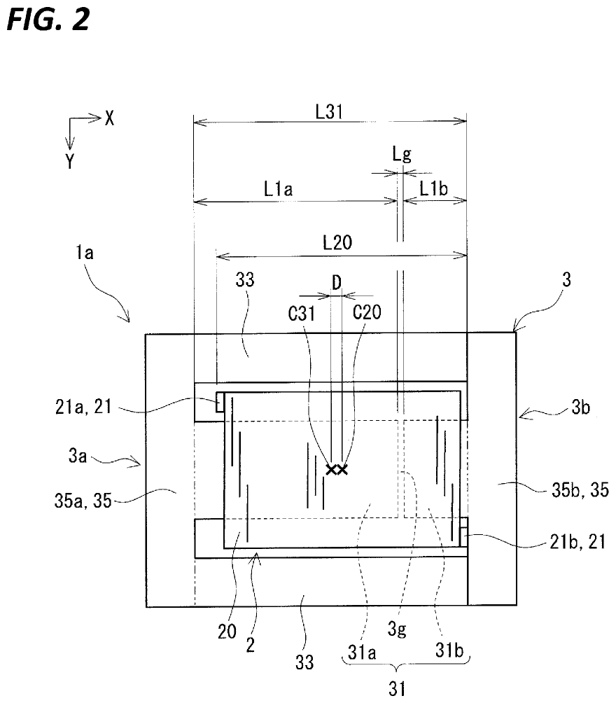

One of features of the reactor 1a of the first embodiment is to satisfy the following requirements (a), (b).
(a) A relative magnetic permeability of the second middle core portion 31b is larger than that of the first middle core portion 31a.
(b) As shown in FIG. 2, a center position C20 of the winding portion 20 is located in a region closer to the second middle core portion 31b than a center position C31 of the middle core portion 31.

The reactor 1a can increase an inductance as compared to the case where the center position C20 of the winding portion 20 is the same position as the center position C31 of the middle core portion 31. The configuration of the reactor 1a is described in detail below.

### <Coil>

As shown in FIGS. 1 and 2, the coil 2 includes one winding portion 20. The winding portion 20 is a part formed by spirally winding a winding wire. A known winding wire can be used as the winding wire. The winding wire is a coated rectangular wire including a conductor wire and an insulation coating covering the conductor wire. The conductor wire is a rectangular wire made of copper. The insulation coating is made of enamel. In this embodiment, the coil 2 is an edgewise coil formed by winding the coated rectangular wire in an edgewise manner.

The winding portion 20 has a tubular shape. The winding portion 20 may have a polygonal tube shape or a circular tube shape. The polygonal tube shape has a polygonal contour shape of an end surface when viewed from a direction along an axis of the winding portion 20. The direction along the axis of the winding portion 20 is a direction from a first end part toward a second end part of the winding portion 20. The polygonal shapes include, for example, quadrilateral shapes, hexagonal shapes and octagonal shapes. The quadrilateral shapes include rectangular shapes. The rectangular shapes include square shapes. The circular tube shape has a circular contour shape of the end surface. The circular shapes include not only true circular shapes, but also elliptical shapes. In this embodiment, the winding portion 20 has a rectangular tube shape.

The coil 2 includes end portions 21. The end portions 21 are parts of the winding wire pulled out from both end parts of the winding portion 20. The end portions 21 include a first end portion 21a and a second end portion 21b. The first end portion 21a is pulled out to an outer peripheral side of the winding portion 20 from the first end part of the winding portion 20. The second end portion 21b is pulled out to the outer peripheral side of the winding portion 20 from the second end part of the winding portion 20. In the first and second end portions 21a, 21b, the insulation coating is stripped to expose the conductor wire. An unillustrated busbar is, for example, connected to the first and second end portions 21a, 21b. The coil 2 is connected to an unillustrated external device by the busbar. The external device is a power supply for supplying power to the coil 2 or the like.

A length L20 of the winding portion 20 shown in FIG. 2 is not particularly limited, but is, for example, 10 mm or more and 60 mm or less, further 20 mm or more and 50 mm or less. The length mentioned here means a length along the axis of the winding portion 20. The length L20 of the winding portion 20 changes depending on a thickness of the winding wire or a turn number. The turn number is, for example, 10 turns or more and 60 turns or less, further 20 turns or more and 50 turns or less.

### <Magnetic Core>

As shown in FIGS. 1 and 2, the magnetic core 3 includes the middle core portion 31, side core portions 33 and end core portions 35. The magnetic core 3 is configured into a θ shape as a whole in a plan view. In this embodiment, the magnetic core 3 includes a first core 3a and a second core 3b. The magnetic core 3 is configured by combining the first and second cores 3a, 3b. The first and second cores 3a, 3b are combined in the direction along the axis of the winding portion 20. In FIG. 2, boundaries between the middle core portion 31 and the end core portions 35 and boundaries between the side core portions 33 and the end core portions 35 are shown by two-dot chain lines. The first and second cores 3a, 3b are described in detail later.

In the following description, an X direction, a Y direction, and a Z direction are defined as follows. The X direction is a direction along the axis of the winding portion 20. The Y direction is a parallel direction of the middle core portion 31 and the side core portions 33. The Y direction is a direction orthogonal to the X direction and a direction from the middle core portion 31 toward the side core portion 33. The Z direction is a direction orthogonal to both the X and Y directions, and a direction away from a center axis of the winding portion 20. In the Z direction, a side where the end portions 21 of the coil 2 are located is referred to as an upper side, and an opposite side thereof is referred to as a lower side. The plan view described above shows a state when the reactor 1a is viewed from above, i.e. from the Z direction.

The magnetic core 3 has a θ shape when viewed from the Z direction as shown in FIG. 2. If the coil 2 is energized, a θ-shaped closed magnetic path is formed in the magnetic core 3. In this closed magnetic path, a magnetic flux generated by the coil 2 returns from the middle core portion 31 to the middle core portion 31 through one of the two end core portions 35, the respective side core portions 33 and the remaining end core portion 35.

### (Middle Core Portion)

The middle core portion 31 includes a part to be arranged inside the winding portion 20. The middle core portion 31 is a part to be sandwiched by first and second end core portions 35a, 35b, out of the magnetic core 3. The first and second end core portions 35a, 35b are described later. One middle core portion 31 is provided. The middle core portion 31 extends along the X direction. A direction along an axis of the middle core portion 31 coincides with the direction along the axis of the winding portion 20. In this embodiment, both end parts of the middle core portion 31 project from both end surfaces of the winding portion 20. These projecting parts are also parts of the middle core portion 31.

The shape of the middle core portion 31 is not particularly limited if this shape corresponds to the inner shape of the winding portion 20. In this embodiment, the middle core portion 31 has a substantially rectangular parallelepiped shape. When viewed from the X direction, corner parts of the outer peripheral surface of the middle core portion 31 may be rounded along the inner peripheral surface of the winding portion 20.

The middle core portion 31 is divided in the X direction and includes the first and second middle core portions 31a, 31b. The first and second middle core portions 31a, 31b are arranged in the X direction. The middle core portion 31 includes a first end part located in a first direction along the X direction and a second end part located in a second direction along the X direction. The first direction along the X direction is a direction from the first middle core portion 31a toward the second middle core portion 31b, i.e. a direction from the first end part toward the second end part of the winding portion 20. The second direction along the X direction is a direction from the second middle core portion 31b toward the first middle core portion 31a, i.e. a direction from the second end part toward the first end part of the winding portion 20. The first end part of the middle core portion 31 is arranged inside the first end part of the winding portion 20. The second end part of the middle core portion 31 is arranged inside the second end part of the winding portion 20. An end surface of the first middle core portion 31a and an end surface of the second middle core portion 31b are facing each other in the X direction. A boundary between the first middle core portion 31a and the second middle core portion 31b is located inside the winding portion 20. The second middle core portion 31b is located side by side with the first middle core portion 31a in the X direction. In FIG. 2, the first middle core portion 31a is located on a left side and the second middle core portion 31b is located on a right side.

A length L31 of the middle core portion 31 shown in FIG. 2 is longer than the length L20 of the winding portion 20. The length L31 of the middle core portion 31 is a length along the X direction. The length L31 of the middle core portion 31 is equal to a distance between mutually facing surfaces of the first and second end core portions 35a, 35b. The length L31 of the middle core portion 31 is, for example, 105% or more and 120% or less of the length L20 of the winding portion 20. The length L31 may be 105% or more and 115% or less, further 105% or more and 110% or less, of the length L20. Further, a difference between the length L31 and the length L20 is, for example, 1.0 mm or more and 6.0 mm or less. That is, the length L31 of the middle core portion 31 is longer than the length L20 of the winding portion 20 by 1.0 mm or more and 6.0 mm or less. The difference between the length L31 and the length L20 may be 1.5 mm or more and 5.0 mm or less, further 2.0 mm or more and 4.0 mm or less.

A length of each of the first and second middle core portions 31a, 31b may be set as appropriate. The lengths mentioned here mean lengths along the X direction. In this embodiment, a length L1a of the first middle core portion 31a and a length L1b of the second middle core portion 31b are different. The length L1a is longer than the length L1b. Unlike this embodiment, the length L1a may be shorter than the length L1b or the length L1a and the length L1b may be equal.

In this embodiment, the middle core portion 31 includes a gap portion 3g. The gap portion 3g is provided between the first and second middle core portions 31a, 31b. The gap portion 3g is located inside the winding portion 20. By locating the gap portion 3g inside the winding portion 20, a leakage magnetic flux from the gap portion 3g is reduced as compared to the case where the gap portion 3g is located outside the winding portion 20. Thus, a loss due to the leakage magnetic flux from the gap portion 3g can be reduced. A length Lg along the X direction of the gap portion 3g may be set as appropriate to obtain a predetermined inductance. The length Lg of the gap portion 3g is, for example, 0.1 mm or more and 2 mm or less, 0.3 mm or more and 1.5 mm or less, further 0.5 mm or more and 1 mm or less. The gap portion 3g may be an air gap. A nonmagnetic body made of resin or ceramic may be arranged in the gap portion 3g. If the middle core portion 31 includes the gap portion 3g, the length L31 of the middle core portion 31 includes the length Lg of the gap portion 3g. The length L31 of the middle core portion 31 is a total length of the length L1a of the first middle core portion 31a, the length L1b of the second middle core portion 31b and the length Lg of the gap portion 3g. Unlike this embodiment, the gap portion 3g may not be present. In this case, the end surface of the first middle core portion 31a and that of the second middle core portion 31b are in contact with each other and there is substantially no clearance between the first and second middle core portions 31a, 31b.

### (End Core Portions)

The end core portions 35 are parts to be arranged outside the winding portion 20. The end core portions 35 include the first end core portion 35a and the second end core portion 35b. Two end core portions 35 are provided. The two end core portions 35 are arranged apart in the X direction. The second end core portion 35b is located away from the first end core portion 35a in the X direction. The first end core portion 35a is facing the first end surface of the winding portion 20. The first end surface is an end surface of the first end part of the winding portion 20. The first end part of the middle core portion 31, specifically the end part of the first middle core portion 31a, is connected to the first end core portion 35a. The second end core portion 35b is facing the second end surface of the winding portion 20. The second end surface is an end surface of the second end part of the winding portion 20. The second end part of the middle core portion 31, specifically the end part of the second middle core portion 31b, is connected to the second end core portion 35b.

The shape of each of the first and second end core portions 35a, 35b is not particularly limited if the first and second end core portions 35a, 35b are shaped to form a predetermined magnetic path. In this embodiment, each of the first and second end core portions 35a, 35b has a substantially rectangular parallelepiped shape.

### (Side Core Portions)

The side core portions 33 are parts to be arranged outside the winding portion 20. Two side core portions 33 are provided. Each side core portion 33 extends in the X direction. A direction along an axis of each side core portion 33 is parallel to the direction along the axis of the middle core portion 31. The two side core portions 33 are arranged at an interval in the Y direction. The two side core portions 33 are arranged across the middle core portion 31. That is, the middle core portion 31 is arranged between the two side core portions 33. One of the two side core portions 33 is located in a first direction along the Y direction. This side core portion 33 is facing a first side surface, out of the outer peripheral surface of the winding portion 20. The first side surface is a surface facing in the first direction along the Y direction in the winding portion 20. In FIG. 2, this side core portion 33 is located on an upper side. The remaining one of the two side core portions 33 is located in a second direction along the Y direction. This side core portion 33 is facing a second side surface, out of the outer peripheral surface of the winding portion 20. The second side surface is a surface facing in the second direction along the Y direction in the winding portion 20. In FIG. 2, this side core portion 33 is located on a lower side. The side core portion 33 includes a first end part located in the first direction along the X direction and a second end part located in the second direction along the X direction. The first end part of the side core portion 33 is connected to the first end core portion 35a. The second end part of the side core portion 33 is connected to the second end core portion 35b. Cross-sectional areas of the respective side core portions 33 may be equal or different. In this embodiment, the cross-sectional areas of the two side core portions 33 are equal. Further, in this embodiment, a total cross-sectional area of the two side core portions 33 is equal to a cross-sectional area of the middle core portion 31. The cross-sectional area mentioned here means an area of a cross-section orthogonal to the X direction.

Each side core portion 33 may have a length to link the first and second end core portions 35a, 35b. The shape of the side core portion 33 is not particularly limited. In this embodiment, each side core portion 33 has a substantially rectangular parallelepiped shape.

### <First Core, Second Core>

The first core 3a includes the first middle core portion 31a. The second core 3b includes the second middle core portion 31b. The shapes of the first and second cores 3a, 3b can be selected from various combinations. In this embodiment, the magnetic core 3 is of an E-T type by combining the E-shaped first core 3a and the T-shaped second core 3b as shown in FIGS. 1 and 2.

### <First Core>

In this embodiment, the first core 3a includes the first middle core portion 31a, the first end core portion 35a and the two side core portions 33. The first middle core portion 31a, the first end core portion 35a and the two side core portions 33 are integrally formed. Since the first core 3a is an integrally formed body, each core portion constituting the first core 3a is made of the same material. That is, each core portion constituting the first core 3a has substantially the same magnetic properties and mechanical properties. The first middle core portion 31a extends in the X direction from an intermediate part in the Y direction of the first end core portion 35a toward the second middle core portion 31b. The respective side core portions 33 extend from both end parts in the Y direction of the first end core portion 35a toward the second end core portion 35b. The first core 3a is E-shaped when viewed from the Z direction.

### <Second Core>

In this embodiment, the second core 3b includes the second middle core portion 31b and the second end core portion 35b. The second middle core portion 31b and the second end core portion 35b are integrally formed. Since the second core 3b is an integrally formed body, each core portion constituting the second core 3b is made of the same material. That is, each core portion constituting the second core 3b has substantially the same magnetic properties and mechanical properties. The second middle core portion 31b extends in the X direction from an intermediate part in the Y direction of the second end core portion 35b toward the first middle core portion 31a. The second core 3b is T-shaped when viewed from the Z direction.

In this embodiment, the magnetic core 3 is composed of two pieces including the first and second cores 3a, 3b. That is, the division number of the magnetic core 3 is two. The division number of the magnetic core 3 and positions where the magnetic core 3 is divided are not particularly limited. The magnetic core 3 may be composed of three or more pieces. For example, the first end core portion 35a, the second end core portion 35b, the first middle core portion 31a, the second middle core portion 31b and the two side core portions 33 may be respectively individually configured, and the magnetic core 3 may be configured by combining these. If the magnetic core 3 is composed of the first and second cores 3a, 3b as in this embodiment, the magnetic core 3 is easily assembled since there are only two core pieces to be combined.

### (Relationship of Relative Magnetic Permeability of First Middle Core Portion and Relative Magnetic Permeability of Second Middle Core Portion)

A relative magnetic permeability of the second core 3b is larger than that of the first core 3a. That is, in the middle core portion 31, a relative magnetic permeability of the second middle core portion 31b is larger than that of the first middle core portion 31a. A difference between the relative magnetic permeability of the second middle core portion 31b and that of the first middle core portion 31b is preferably, for example, 50 or more. An upper limit of the relative magnetic permeability difference is practically, for example, about 500. The relative magnetic permeability difference may be 50 or more and 500 or less, further 100 or more and 400 or less.

The relative magnetic permeability of each of the first and second cores 3a, 3b may be set as appropriate to obtain a predetermined inductance after satisfying the above relationship. The relative magnetic permeability of the first middle core portion 31a is, for example, 5 or more and 50 or less. The relative magnetic permeability of the second middle core portion 31b is, for example, 50 or more and 500 or less. If the relative magnetic permeability of the first core 3a is within a range of 5 or more and 50 or less and the relative magnetic permeability of the second core 3b is within a range of 50 or more and 500 or less, a predetermined inductance is easily obtained. The relative magnetic permeability of the first middle core portion 31a may be 10 or more and 45 or less, further 15 or more and 40 or less. The relative magnetic permeability of the second middle core portion 31b is preferably 100 or more and 500 or less. The relative magnetic permeability of the second middle core portion 31b may be 100 or less and 450 or more, further 150 or more and 400 or less.

The relative magnetic permeability can be obtained as follows. A ring-shaped measurement sample is cut out from each of the first and second middle core portions 31a, 31b. Wire winding of 300 winds on a primary side and 20 winds on a secondary side is applied to each measurement sample. A B-H initial magnetization curve is measured in a range of H=0 (Oe) or more and 100 (Oe) or less, and a maximum value of this B-H initial magnetization curve is obtained. This maximum value is set as a relative magnetic permeability. The magnetization curve mentioned here is a so-called direct-current magnetization curve.

### (Material of Middle Core Portion)

The first and second middle core portions 31a, 31b are constituted by compacts of soft magnetic materials. The compacts are, for example, powder compacts or compacts of composite materials. The first and second middle core portions 31a, 31b are constituted by compacts made of mutually different materials. The mutually different materials mean, of course, a case where materials of individual constituent elements are different in the respective compacts constituting the first and second middle core portions 31a, 31b and also a case where contents of constituent elements are different even if materials of individual constituent elements are the same. For example, even if the first and second middle core portions 31a, 31b are constituted by powder compacts, these are made of mutually different materials if at least one of a material and a content of a soft magnetic powder constituting the powder compact is different. Further, even if the first and second middle core portions 31a, 31b are constituted by compacts of composite materials, these are made of mutually different materials if at least one of a material and a content of a soft magnetic powder constituting the composite material is different.

The powder compact is formed by compression-forming a raw material powder containing a soft magnetic powder. The powder compact has a higher content of the soft magnetic powder than the compact of the composite material. Thus, the powder compact has higher magnetic properties than the compact of the composite material. The magnetic properties include, for example, a relative magnetic permeability and a saturated magnetic flux density. The powder compact may contain at least one of a binder resin and a molding aid. A content of the soft magnetic powder in the powder compact is, for example, 85% by volume or more and 99.99% by volume or less when the powder compact is 100% by volume.

In the compact of the composite material, the soft magnetic powder is dispersed in a resin. The compact of the composite material is obtained by filling a fluid raw material, in which the soft magnetic powder is dispersed in the uncured resin, into a mold and solidifying the resin. The compact of the composite material can easily adjust a content of the soft magnetic powder. Thus, the compact of the composite material easily adjusts the magnetic properties. A content of the soft magnetic powder in the compact of the composite material is, for example, 20% by volume or more and 80% by volume or less when the compact of the composite material is 100% by volume.

Particles constituting the soft magnetic powder are at least one type of particles of soft magnetic metal, coated particles including insulation coatings on the outer peripheries of particles of soft magnetic metal and particles of soft magnetic nonmetal. The soft magnetic metal is, for example, pure iron or an iron-based alloy. The iron-based alloy is, for example, a Fe (iron)-Si (silicon) alloy or a Fe—Ni (nickel) alloy. The insulation coating is, for example, a phosphate. The soft magnetic nonmetal is, for example, ferrite.

The resin of the compact of the composite material may be a thermosetting resin or a thermoplastic resin. The thermosetting resin is, for example, an unsaturated polyester resin, an epoxy resin, a urethane resin or a silicone resin. The thermoplastic resin is, for example, a polyphenylene sulfide resin, a polytetrafluoroethylene resin, a liquid crystal polymer, a polyamide resin, a polybutylene terephthalate resin or an acrylonitrile-butadiene-styrene resin. The polyamide resin is, for example, nylon 6, nylon 66 or nylon 9T. Besides, the resin of the compact of the composite material may be, for example, a BMC (Bulk Molding Compound), a millable-type silicone rubber or a millable-type urethane rubber. The BMC is, for example, a mixture of an unsaturated polyester and calcium carbonate or glass fibers.

The compact of the composite material may contain a filler in addition to the soft magnetic powder and the resin. The filler is, for example, a ceramic filler made of alumina or silica. By containing the filler, the compact of the composite material can enhance heat dissipation. A content of the filler is, for example, 0.2% by mass or more and 20% by mass or less, further 0.3% by mass or more and 15% by mass or less, or 0.5% by mass or more and 10% by mass or less when the compact of the composite material is 100% by volume.

A content of the soft magnetic powder in the powder compact or the compact of the composite material is assumed to be equivalent to an area ratio of the soft magnetic powder in a cross-section of the compact. The content of the soft magnetic powder in the compact is obtained as follows. A cross-section of the compact is observed by a scanning electron microscope (SEM) and observation images are obtained. A magnification of the SEM is set to 200× or more and 500× or less. The number of the obtained observation images is 10 or more. A total area of the observation image is set to 0.1 cm² or more. One observation image may be obtained for one cross-section or a plurality of observation images may be obtained for one cross-section. An image processing is applied to each obtained observation image to extract the contours of the particles of the soft magnetic powder. The image processing is, for example, a binarization processing. A total area of the particles of the soft magnetic powder in each observation image is calculated, and an area ratio of the particles of the soft magnetic powder in each observation image is obtained. An average value of the area ratios in all the observation images is assumed as the content of the soft magnetic powder.

In this embodiment, the first core 3a including the first middle core portion 31a is the compact of the composite material. The second core 3b including the second middle core portion 31b is the powder compact. By constituting the first core 3a by the compact of the composite material and constituting the second core 3b by the powder compact, the magnetic properties of the entire magnetic core 3 can be adjusted. Further, if the first core 3a is constituted by the compact of the composite material and the second core 3b is constituted by the powder compact, the relative magnetic permeability of each of the first and second middle core portions 31a, 31b easily satisfies the above relationship. In this embodiment, the relative magnetic permeability of the first middle core portion 31a is about 20 or more and 30 or less. The relative magnetic permeability of the second middle core portion 31b is about 150 or more and 250 or less. A difference between the relative magnetic permeability of the second middle core portion 31b and that of the first middle core portion 31a is about 120 or more and 230 or less.

### (Position of Winding Portion on Middle Core Portion)

As shown in FIG. 2, the center position C20 of the winding portion 20 is located in the region closer to the second middle core portion 31b than the center position C31 of the middle core portion 31. That is, the center position C20 of the winding portion 20 is closer to the second core 3b than the center position C31 of the middle core portion 31. Here, the center position C20 of the winding portion 20 is a center in the X direction of the winding portion 20 and bisects the length L20 of the winding portion 20. The center position C31 of the middle core portion 31 is a center in the X direction of the middle core portion 31 and bisects the length L31 of the middle core portion 31. Further, that the center position C20 of the winding portion 20 is located in the region closer to the second middle core portion 31b than the center position C31 of the middle core portion 31 means that a distance D between the center position C20 of the winding portion 20 and the center position C31 of the middle core portion 31 is larger than an error range. The distance D is a distance in the X direction from the center position C31 to the center position C20. A range in which the distance D is less than 1% of the length L20 of the winding portion 20 is regarded as the error range. The distance D is, for example, preferably 1% or more of the length L20 of the winding portion 20. An upper limit of the distance D is half the difference between the length L31 of the middle core portion 31 and the length L20 of the winding portion 20. The distance D may be 1% or more and 15% or less, further 1.5% or more and 10% or less, of the length L20 of the winding portion 20. Specific numerical values of the distance D are, for example, 0.5 mm or more and 3.0 mm or less, further 1.0 mm or more and 2.0 mm or less. The distance D is particularly preferably 1.0 mm or more.

### Miscellaneous

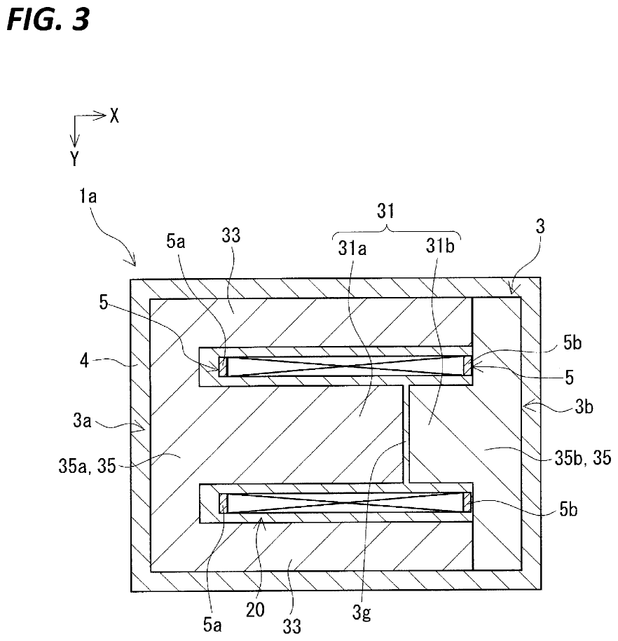

The reactor 1a is provided with a resin molded member 4 and holding members 5 as other components. The resin molded member 4 is shown by two-dot chain lines in FIG. 1. The resin molded member 4 is not shown in FIG. 2. In FIGS. 1 and 2, the holding members 5 are not shown. FIG. 3 shows a cross-section of the reactor 1a cut by a plane orthogonal to the Z direction at an intermediate position in the Z direction of the magnetic core 3. The center axis of the winding portion 20 passes through the intermediate position in the Z direction of the magnetic core 3.

### (Resin Molded Member)

The resin molded member 4 covers at least a part of the outer peripheral surface of the magnetic core 3. The resin molded member 4 integrates the combined first and second cores 3a, 3b. Further, the resin molded member 4 integrates the coil 2 and the magnetic core 3. In this embodiment, the resin molded member 4 is filled also between the inner peripheral surface of the winding portion 20 and the middle core portion 31 as shown in FIG. 3. Thus, the coil 2 is held positioned with respect to the magnetic core 3 by the resin molded member 4. Further, electrical insulation between the coil 2 and the magnetic core 3 can be ensured by the resin molded member 4. A resin similar to the resin of the aforementioned compact of the composite material can be, for example, used as a resin for constituting the resin molded member 4. The resin molded member 4 may cover the outer peripheral surface of the winding portion 20. The resin molded member 4 may be formed to expose at least one of the upper and lower surfaces of the winding portion 20.

In this embodiment, the resin of the resin molded member 4 is also filled into the gap portion 3g through between the inner peripheral surface of the winding portion 20 and the middle core portion 31. The gap portion 3g is constituted by the resin of the resin molded member 4.

### (Holding Members)

The holding members 5 are arranged between the coil 2 and the magnetic core 3. The holding members 5 determine relative positions of the coil 2 and the magnetic core 3. Further, electrical insulation between the coil 2 and the magnetic core 3 can be ensured by the holding members 5. In this embodiment, the holding members 5 include a first holding member 5a and a second holding member 5b. The first holding member 5a is an annular member facing the first end surface of the winding portion 20. The first holding member 5a is arranged between the first end surface of the winding portion 20 and the first end core portion 35a. The second holding member 5b is an annular member facing the second end surface of the winding portion 20. The second holding member 5b is arranged between the second end surface of the winding portion 20 and the second end core portion 35b. A resin similar to the resin of the aforementioned compact of the composite material can be, for example, used as a resin for constituting the holding members 5.

A thickness of the first holding member 5a and that of the second holding member 5b may be equal or different. For example, the thickness of the first holding member 5a may be larger than that of the second holding member 5b. The thickness of the first holding member 5a is a distance between a surface facing the first end surface of the winding portion 20 and a surface facing the first end core portion 35a. The thickness of the second holding member 5b is a distance between a surface facing the second end surface of the winding portion 20 and a surface facing the second end core portion 35b. If the aforementioned resin molded member 4 is not provided, the first holding member 5a may be configured to be thicker than the second holding member 5b. By making the first holding member 5a thicker than the second holding member 5b, the winding portion 20 can be positioned with respect to the middle core portion 31 in the X direction even if the aforementioned resin molded member 4 is absent.

The reactor 1a of the first embodiment can increase an inductance as compared to a reference reactor in which the center position C20 of the winding portion 20 and the center position C31 of the middle core portion 31 are the same position. The reason for that is that a ratio of the second middle core portion 31b arranged inside the winding portion 20 increases by locating the center position C20 of the winding portion 20 in the region closer to the second middle core portion 31b than the center position C31 of the middle core portion 31. Since a magnetic flux passing through the second middle core portion 31b having a high relative magnetic permeability increases, the inductance increases.

The reactor 1a increases the inductance more than the reference reactor only by shifting the position of the winding portion 20 toward the second core 3b without changing the turn number of the winding portion 20 and the size of the magnetic core 3. Since the inductance increases, the reactor 1a can ensure the same inductance as the reference reactor even if the turn number of the winding portion 20 is reduced or the magnetic core 3 is reduced in size. Thus, the reactor 1a can be reduced in size while a predetermined inductance is ensured.

If the difference between the relative magnetic permeability of the second middle core portion 31b and that of the first middle core portion 31a is 50 or more, the inductance is easily increased. Further, if the distance D between the center position C20 of the winding portion 20 and the center position C31 of the middle core portion 31 is 1% or more of the length L20 of the winding portion 20, the inductance is easily increased. Particularly, if the distance D is 1.0 mm or more, the inductance can be effectively increased.

### Second Embodiment

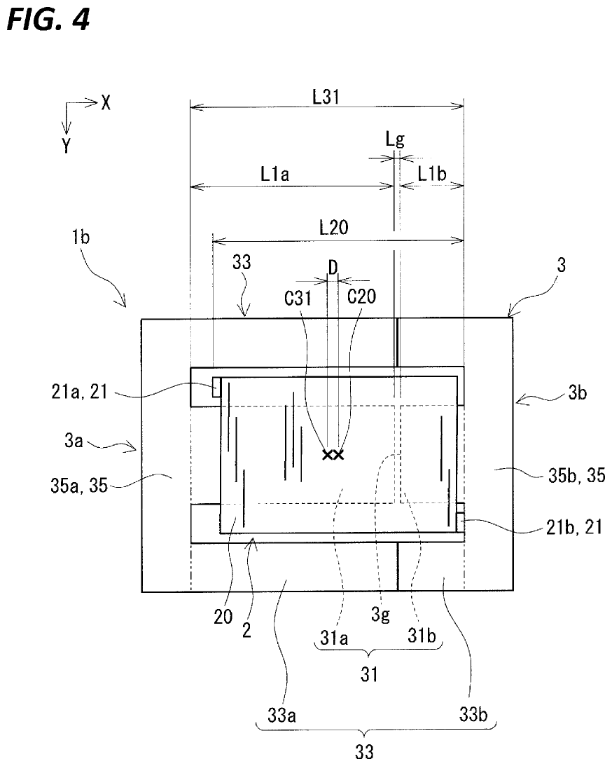

A reactor 1b of a second embodiment is described with reference to FIG. 4. The reactor 1b of the second embodiment differs from the reactor 1a of the first embodiment in that a magnetic core 3 is of an E-E type. The following description is centered on points of difference from the first embodiment. Components similar to those of the first embodiment are denoted by the same reference signs and not described. The resin molded member 4 and the holding members 5 described in the first embodiment are not shown in FIG. 4.

### <Magnetic Core>

The magnetic core 3 is configured by combining a first core 3a and a second core 3b in the X direction as in the first embodiment. The magnetic core 3 has a θ shape when viewed from the Z direction as shown in FIG. 4. In FIG. 4, boundaries between a middle core portion 31 and end core portions 35 and boundaries between side core portions 33 and the end core portions 35 are shown by two-dot chain lines.

In the second embodiment, each of the two side core portions 33 is divided in the X direction. The side core portion 33 includes a first side core portion 33a and a second side core portion 33b. The first and second side core portions 33a, 33b are arranged in the X direction. The first side core portion 33a is located in the first direction along the X direction. An end part of the first side core portion 33a is connected to a first end core portion 35a. The second side core portion 33b is located in the second direction along the X direction. An end part of the second side core portion 33b is connected to a second end core portion 35b.

An end surface of the first side core portion 33a and that of the second side core portion 33b are in contact with each other. A length of each of the first and second side core portions 33a, 33b may be set as appropriate. The length mentioned here means a length along the X direction. In FIG. 4, the first side core portion 33a is longer than the second side core portion 33b. The first side core portion 33a may be shorter than the second side core portion 33b. The length of the first side core portion 33a and that of the second side core portion 33b may be equal.

The first core 3a includes a first middle core portion 31a, the first end core portion 35a and two first side core portions 33a. The first middle core portion 31a, the first end core portion 35a and the two first side core portions 33a are integrally formed. The respective first side core portions 33a extend in the X direction from both end parts in the Y direction of the first end core portion 35a toward the second side core portions 33b. The first core 3a is E-shaped when viewed from the Z direction.

The second core 3b includes a second middle core portion 31b, the second end core portion 35b and two second side core portions 33b. The second middle core portion 31b, the second end core portion 35b and the two second side core portions 33b are integrally formed. The respective second side core portions 33b extend in the X direction from both end parts in the Y direction of the second end core portion 35b toward the first side core portions 33a. The second core 3b is E-shaped when viewed from the Z direction.

A relationship of a relative magnetic permeability of the first core 3a and that of the second core 3b is similar to that of the first embodiment. That is, a relative magnetic permeability of the second middle core portion 31b is larger than that of the first middle core portion 31a. Further, a center position C20 of a winding portion 20 is located in a region closer to the second middle core portion 31b than a center position C31 of the middle core portion 31 as in the first embodiment.

The reactor 1b of the second embodiment can increase an inductance, similarly to the reactor 1a of the first embodiment.

### Third Embodiment

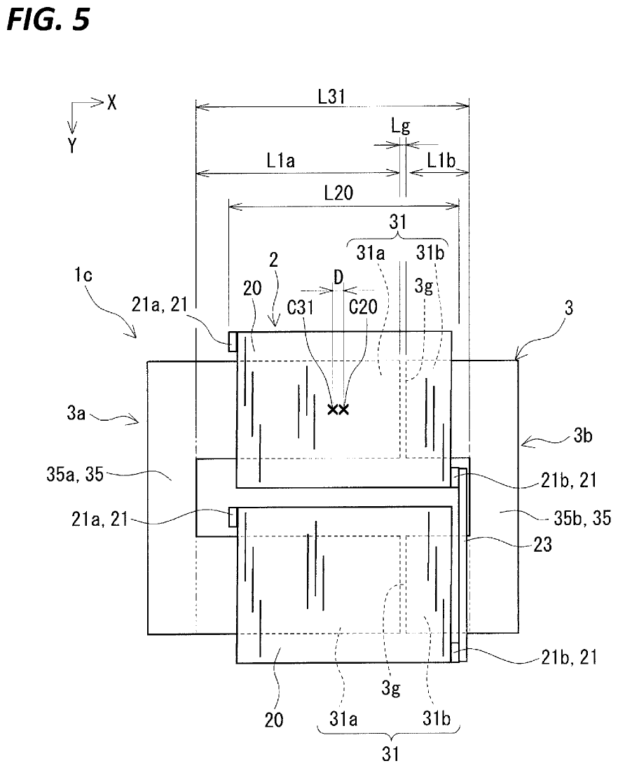

A reactor 1c of a third embodiment is described with reference to FIG. 5. The reactor 1c of the third embodiment differs from the reactor 1a of the first embodiment in that a coil 2 includes two winding portions 20 and a magnetic core 3 is of a U-U type. The following description is centered on points of difference from the first embodiment. Components similar to those of the first embodiment are denoted by the same reference signs and not described. The resin molded member 4 and the holding members 5 described in the first embodiment are not shown in FIG. 5.

### <Coil>

The coil 2 includes two winding portions 20. The two winding portions 20 are arranged in parallel so that axes thereof are parallel. Each winding portion 20 has a rectangular tube shape. A length L20 of each winding portion 20 is equal. Each winding portion 20 has the same turn number.

The two winding portions 20 shown in FIG. 5 are configured by spirally winding separate winding wires. In FIG. 5, second end portions 21b pulled out from second end parts of the respective winding portions 20 are electrically connected by a coupling member 23. The coupling member 23 is, for example, made of the same material as the winding wires. An unillustrated busbar is connected to first end portions 21a pulled out from first end parts of the respective winding portions 20. The two winding portions 20 may be constituted by one continuous winding wire. In this case, a method for forming the two winding portions 20 is, for example, such that, after one winding portion 20 is formed from the first end part, the winding wire is bent and folded into a U shape at the second end part of the one winding portion 20, and the remaining winding portion 20 is formed from the second end part.

### <Magnetic Core>

The magnetic core 3 is configured by combining a first core 3a and a second core 3b in the X direction as in the first embodiment. The magnetic core 3 has an O shape when viewed from the Z direction as shown in FIG. 5. In the third embodiment, the magnetic core 3 includes two middle core portions 31 and two end core portions 35. A parallel direction of the two middle core portions 31 is the Y direction. In FIG. 5, boundaries between the middle core portions 31 and the end core portions 35 are shown by two-dot chain lines.

Each of the two middle core portions 31 extends in the X direction. The two middle core portions 31 are arranged in parallel such that axes thereof are parallel. The respective middle core portions 31 include parts to be arranged inside the two winding portions 20. Each middle core portion 31 has a substantially rectangular parallelepiped shape. Each middle core portion 31 is divided in the X direction and includes a first middle core portion 31a and a second middle core portion 31b. Each first middle core portion 31a is located in the first direction along the X direction. Each second middle core portion 31b is located in the second direction along the X direction.

Lengths L31 of the two middle core portions 31 are equal. The length L31 of the middle core portion 31 is longer than a length L20 of the winding portion 20. In FIG. 5, a length L1a of each first middle core portion 31a is longer than a length L1b of each second middle core portion 31b. Further, each middle core portion 31 includes a gap portion 3g. The gap portion 3g is provided between the first and second middle core portions 31a, 31b.

The end core portions 35 include a first end core portion 35a and a second end core portion 35b. The first end core portion 35a is located in the first direction along the X direction and facing a first end surface of each winding portion 20. An end part of each first middle core portion 31a is connected to the first end core portion 35a. That is, the first end core portion 35a links the end parts of the first middle core portions 31a. The second end core portion 35b is located in the second direction along the X direction and facing a second end surface of each winding portion 20. An end part of each second middle core portion 31b is connected to the second end core portion 35b. That is, the second end core portion 35b links the end parts of the second middle core portions 31b. Each of the first and second end core portions 35a, 35b has a substantially rectangular parallelepiped shape.

The first core 3a includes the first middle core portion 31a of each of the two middle core portions 31 and the first end core portion 35a. The two first middle core portions 31a and the first end core portion 35a are integrally formed. The respective first middle core portions 31a extend in the X direction from both end parts in the Y direction of the first end core portion 35a toward the respective second middle core portions 31b. The first core 3a is U-shaped when viewed from the Z direction.

The second core 3b includes the second middle core portion 31b of each of the two middle core portions 31 and the second end core portion 35b. The two second middle core portions 31b and the second end core portion 35b are integrally formed. The respective second middle core portions 31b extend in the X direction from both end parts in the Y direction of the second end core portion 35b toward the respective first middle core portions 31a. The second core 3b is U-shaped when viewed from the Z direction.

A relationship of a relative magnetic permeability of the first core 3a and that of the second core 3b is similar to that of the first embodiment. That is, a relative magnetic permeability of the second middle core portion 31b is larger than that of the first middle core portion 31a. Further, a center position C20 of each winding portion 20 is located in a region closer to the second middle core portion 31b than a center position C31 of each middle core portion 31 as in the first embodiment.

The reactor 1c of the third embodiment can increase an inductance, similarly to the reactor 1a of the first embodiment.

### Fourth Embodiment

### [Converter, Power Conversion Device]

The reactors of the first to third embodiments can be utilized for applications satisfying the following energizing conditions. The energizing conditions include, for example, a maximum direct current of about 100 A or more and 1000 A or less, an average voltage of about 100 V or more and 1000 V or less and a use frequency of about 5 kHz or more and 100 kHz or less. The reactors 1a, 1b and 1c of the first to third embodiments can be typically used as a constituent component of a converter to be installed in a vehicle such as an electric vehicle or a hybrid vehicle or as a constituent component of a power conversion device provided with this converter.

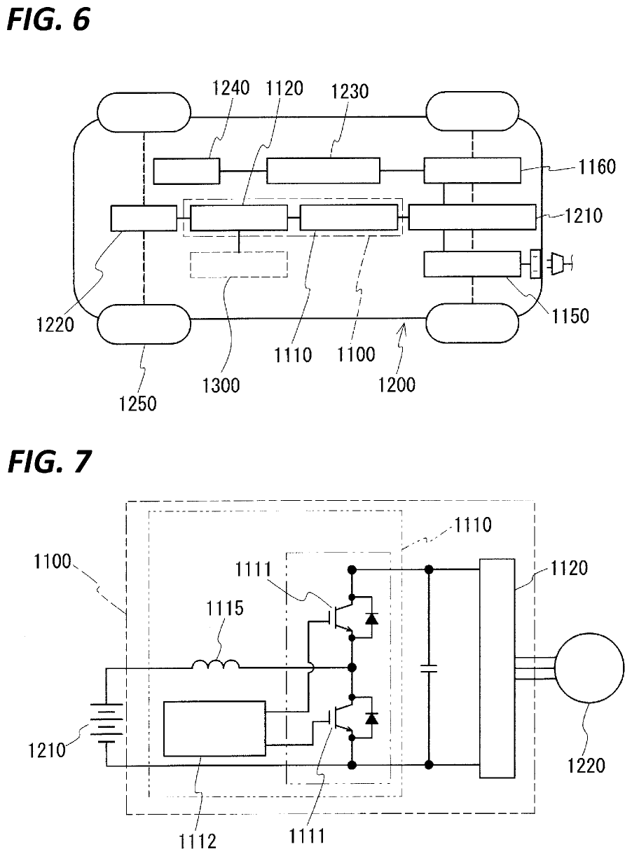

A vehicle 1200 such as a hybrid vehicle or an electric vehicle is, as shown in FIG. 6, provided with a main battery 1210, a power conversion device 1100 connected to the main body 1210 and a motor 1220 used for travel by being driven by power supplied from the main body 1210. The motor 1220 is, typically, a three-phase alternating current motor. The motor 1220 drives wheels 1250 during travel and functions as a generator during regeneration. In the case of a hybrid vehicle, the vehicle 1200 includes an engine 1300 in addition to the motor 1220. FIG. 6 shows an inlet as a charging point of the vehicle 1200, but the vehicle 1200 can include a plug.

The power conversion device 1100 includes a converter 1110 to be connected to the main battery 1210 and an inverter 1120 connected to the converter 1110 for the mutual conversion of a direct current and an alternating current. The converter 1110 shown in this example steps up an input voltage of the main battery 1210 of about 200 V or more and 300 V or less to about 400 V or more and 700 V or less and supplies the stepped-up voltage to the inverter 1120 during the travel of the vehicle 1200. The converter 1110 steps down an input voltage output from the motor 1220 via the inverter 1120 to a direct-current voltage suitable for the main battery 1210 and charges the main battery 1210 with the direct-current voltage during regeneration. The input voltage is a direct-current voltage. The inverter 1120 converts the direct current stepped up by the converter 1110 into a predetermined alternating current and supplies the converted current to the motor 1220 during the travel of the vehicle 1200 and converts an alternating current output from the motor 1220 into a direct current and outputs the direct current to the converter 1110 during regeneration.

The converter 1110 includes a plurality of switching elements 1111, a drive circuit 1112 for controlling the operation of the switching elements 1111 and a reactor 1115 as shown in FIG. 7 and converts an input voltage by being repeatedly turned on and off. The conversion of the input voltage means voltage step-up and -down here. A power device such as a field effect transistor or an insulated gate bipolar transistor is used as the switching element 1111. The reactor 1115 has a function of smoothing a change of a current when the current is increased or decreased by a switching operation, using a property of a coil to hinder a change of a current flowing into a circuit. Any one of the reactors of the first to third embodiments is provided as the reactor 1115. By including the reactor having a large inductance, the reactor can be reduced in size, wherefore the power conversion device 1100 and the converter 1110 can be reduced in size.

Besides the converter 1110, the vehicle 1200 is provided with a power supply device converter 1150 connected to the main battery 1210 and an auxiliary power supply converter 1160 connected to a sub-battery 1230 and the main battery 1210 serving as power sources of auxiliary devices 1240 and configured to convert a high voltage of the main battery 1210 into a low voltage. The converter 1110 typically performs DC-DC conversion, but the power supply device converter 1150 and the auxiliary power supply converter 1160 perform AC-DC conversion. The power supply device converter 1150 may perform DC-DC conversion. Reactors configured similarly to any one of the reactors of the first to third embodiments and appropriately changed in size, shape and the like can be used as reactors of the power supply device converter 1150 and the auxiliary power supply converter 1160. Further, any one of the reactors of the first to third embodiments can also be used as a converter for converting input power and only stepping up a voltage or only stepping down a voltage.

### Test Example 1

Inductances were evaluated for reactors configured similarly to the reactor 1a of the first embodiment.

In Text Example 1, inductances were analyzed by CAE (Computer Aided Engineering) for Sample No. 1-1 and Sample No. 10. In Sample No. 1-1, the center position C20 of the winding portion 20 is located in the region closer to the second middle core portion 31b than the center position C31 of the middle core portion 31. In Sample No. 10, the center position C20 of the winding portion 20 is the same position as the center position C31 of the middle core portion 31. The configuration of the samples of the reactors used in Test Example 1 were set as follows.

### (Coil)

Length L20 of the winding portion 20: 38 mm
Turn number: 30 turns

### (Magnetic Core)

Length L31 of the middle core portion 31: 43 mm
Length L1a of the first middle core portion 31a: 32 mm
Length L1b of the second middle core portion 31b: 10 mm
Length Lg of the gap portion 3g: 1 mm
Relative magnetic permeability of the first core 3a: 25
Relative magnetic permeability of the second core 3b: 200
Material of the first core 3a: compact of composite material
Material of second core 3b: powder compact

In Sample No. 1-1, the distance D between the center position C20 of the winding portion 20 and the center position C31 of the middle core portion 31 was set to 1.0 mm. That is, the distance D in Sample No. 1-1 is 2.6% of the length L20 of the winding portion 20. In Sample No. 10, the distance D is zero.

The inductance when a direct current was caused to flow into the coil was obtained for the reactor of each sample. An electromagnetic field analysis software JMAG-Designer 19.0 produced by JSOL Corporation was used to analyze the inductance. A current was varied in a range of 0 A to 300 A. Each inductance when a current value was 0 A, 100 A, 200 A and 300 A was shown in Table 1. In Table 1, the inductance at each current value in Sample No. 1-1 is shown in percent with the inductance at each current value in Sample No. 10 set as 100. Further, an increase rate of the inductance at each current value in Sample No. 1-1 is shown on the basis of the inductance at each current value in Sample No. 10 in Table 1. The increase rate is a ratio obtained by dividing a value obtained by subtracting the inductance of Sample No. 10 from the inductance of Sample No. 1-1 by the inductance of Sample No. 10.

TABLE 1

| | No. 10 | No. 1-1 | Increase Rate (%) |
|---|---|---|---|
| Distance D (mm) | 0 | 1.0 | of Inductance |

| | | | | |
|---|---|---|---|---|
| Inductance | 0 A | 100 | 100.6 | 0.6 |
| (%) | 100 A | 100 | 100.9 | 0.9 |
| | 200 A | 100 | 100.5 | 0.5 |
| | 300 A | 100 | 100.1 | 0.1 |

As shown in Table 1, the reactor of Sample No. 1-1 had a larger inductance than the reactor of Sample No. 10. The inductance at each current value of 0 A to 300 A in Sample No. 1-1 was larger than the inductance at each current value in Sample No. 10.

### LIST OF REFERENCE NUMERALS

1a, 1b, 1c reactor
2 coil
20 winding portion
21 end portion, 21a first end portion, 21b second end portion
23 coupling member
3 magnetic core
3a first core, 3b second core
31 middle core portion
31a first middle core portion, 31b second middle core portion
33 side core portion
33a first side core, 33b second side core portion
35 end core portion
35a first end core portion, 35b second end core portion
3g gap portion
4 resin molded member
5 holding member
5a first holding member, 5b second holding member
C20, C31 center position
D distance
L20, L31, L1a, L1b, Lg length
1100 power conversion device
1110 converter, 1111 switching element, 1112 drive circuit
1115 reactor, 1120 inverter
1150 power supply device converter, 1160 auxiliary power supply converter
1200 vehicle
1210 main battery, 1220 motor, 1230 sub-battery
1240 auxiliary devices, 1250 wheel
1300 engine

1. A reactor, comprising:
a coil including a winding portion; and
a magnetic core including a middle core portion,
the winding portion being arranged on the middle core portion,
the middle core portion including a first middle core portion and a second middle core portion divided in a direction along an axis of the winding portion,
a relative magnetic permeability of the second middle core portion being larger than that of the first middle core portion, and
a center position of the winding portion in the direction along the axis being located in a region closer to the second middle core portion than a center position of the middle core portion in the direction along the axis.

2. The reactor of claim 1, wherein a difference between the relative magnetic permeability of the second middle core portion and that of the first middle core portion is 50 or more.

3. The reactor of claim 1, wherein a distance between the center position of the winding portion and that of the middle core portion is 1% or more of a length of the winding portion along the axis.

4. The reactor of claim 3, wherein the distance is 1.0 mm or more.

5. The reactor of claim 1, wherein the relative magnetic permeability of the first middle core portion is 5 or more and 50 or less.

6. The reactor of claim 1, wherein the relative magnetic permeability of the second middle core portion is 50 or more and 500 or less.

7. The reactor of claim 1, wherein:
the first middle core portion is constituted by a compact of a composite material in which a soft magnetic powder is dispersed in a resin, and
the second middle core portion is constituted by a powder compact of a raw powder containing a soft magnetic powder.

8. The reactor of claim 1, wherein:
the middle core portion includes a gap portion between the first and second middle core portions, and
the gap portion is located inside the winding portion.

9. The reactor of claim 1, wherein:
the magnetic core is composed of a first core and a second core,
the first core includes the first middle core portion, and
the second core includes the second middle core portion.

10. A converter, comprising the reactor of claim 1.

11. A power conversion device, comprising the converter of claim 10.
